(19) United States
(12) Patent Application Publication
(10) Pub. No.: US 2016/0292718 A1
(43) Pub. Date: Oct. 6, 2016

(54) SYSTEM FOR DETERMINING EFFECTIVENESS OF ADVERTISEMENT CAMPAIGNS

(71) Applicants: Adarsh JAIN, Greater Noida (IN); Vinish KATHURIA, Gurgaon (IN); Shashank AGARWAL, Jaipur (IN)

(72) Inventors: Adarsh JAIN, Greater Noida (IN); Vinish KATHURIA, Gurgaon (IN); Shashank AGARWAL, Jaipur (IN)

(73) Assignee: HT MOBILE SOLUTIONS LTD, New Delhi (IN)

(21) Appl. No.: 14/679,038

(22) Filed: Apr. 6, 2015

(51) Int. Cl. G06Q 30/02

(52) U.S. Cl. CPC G06Q 30/0246

(57) ABSTRACT

A system is provided. The system includes at least one processor. The processor may be configured to receive information associated with an instance of an application installed in a mobile communication device. Further, the processor may receive one or more notifications from the instance of the application confirming its presence in the mobile communication device. The processor may record un-installation of the instance of the application from the mobile communication device upon failure to receive expected one or more notifications confirming the presence of the application in the mobile communication device. The processor may further attribute the un-installation to at least a part of the information associated with the instance of the application.

### BACKGROUND

1. Field

The subject matter in general relates to advertisement. More particularly, but not exclusively, the subject matter relates to advertisement campaigns and determination of its effectiveness.

2. Discussion of Related Field

Marketing of products involve communicating to the potential customers through newspapers, magazines, radio advertisement, television advertisement, outdoor advertisement and digital advertisements. Digital marketing may involve marketing using electronic devices namely personal computers, laptops, smart phones, tablets, cell phones and gaming consoles, among others.

With the advent of smart phones and tablets, mobile application developers have started marketing their mobile applications through digital advertisement means. Digital advertisement means may include SMS, websites, emails, social networking sites, professional networking sites and mobile applications, among others.

Conventionally, ascertaining effectiveness of advertisement may be enabled by providing statistics such as number instances of an application downloaded, the advertisement campaigns and the advertisement publishers responsible for such downloads. Advertisement campaigns may be designed based on such statistics. However, it has been observed that considering such statistics as a key parameter for selecting advertisement means may not be fool proof.

Mobile applications in which advertisements can be placed may be developed with an objective to lure or entice their users into downloading applications that are advertised in them. There may be a scenario where a user, subsequent to downloading the advertised application, may uninstall the downloaded application, thereby making the advertisement campaign ineffective. Further, such downloads may not result in user engagement. Mere downloads may not result in capturing significant amount of quality or targeted audience.

In light of the foregoing discussion, there may be a need for a technique to enable relatively effective campaigns by providing information derived from a technical solution.

### SUMMARY

In an embodiment, a system is provided. The system includes at least one processor. The processor may be configured to receive information associated with an instance of an application installed in a mobile communication device. Further, the processor may receive one or more notifications from the instance of the application confirming its presence in the mobile communication device. The processor may record un-installation of the instance of the application from the mobile communication device upon failure to receive expected one or more notifications confirming the presence of the application in the mobile communication device. The processor may further attribute the un-installation to at least a part of the information associated with the instance of the application.

In another embodiment, a method is provided. The method may include sending information associated with an instance of an application installed in a mobile communication device. Further, one or more notifications may be sent confirming presence of the instance of the application in the mobile communication device, thereby enabling recording un-installation of the instance of the application from the mobile communication device upon failure to send expected one or more notifications confirming the presence of the instance of the application in the mobile communication device. The method may further include attributing the un-installation to at least a part of the information associated with the instance of the application.

### BRIEF DESCRIPTION OF DRAWINGS

Embodiments are illustrated by way of example and not limitation in the Figures of the accompanying drawings, in which like references indicate similar elements and in which:

FIG. 1 is a block diagram of a system 100 for determining effectiveness of an advertisement campaign, in accordance with an embodiment;

FIG. 2 is a flowchart of an exemplary method for enabling tracking of an instance of a mobile application;

FIG. 3 is a flowchart of an exemplary method for enabling tracking un-installation of a mobile application and attributing the same to a digital means responsible for its installation; and

FIG. 4 is a flowchart of another exemplary method for enabling tracking un-installation of a mobile application and attributing the same to a digital means responsible for its installation.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The subject matter may relate to the field of advertisement campaigns. More particularly but not exclusively, the subject matter may relate to a technique for digital advertisement campaigns and determination of its effectiveness.

In an embodiment, a mobile application may have to be advertised to enhance the number of downloads and installations of said application. One may choose to advertise the mobile application (may be referred to as “advertised mobile application”) in one or more digital publishing means. The digital publishing means may include SMS, websites, emails, social networking sites, professional networking sites and mobile applications, among others. A user who uses one or more of publishing means may be rendered with an advertisement of the advertised mobile application. Some of the users may eventually download and install the advertised mobile application on their devices. Each instance of the advertized mobile application installed may be associated with one of the publishing means that led to the installation. Subsequently, one or more notifications from the instance of the application confirming its presence may be sent by the mobile communication device. Failure to send one or more notifications by the mobile communication device may be regarded as un-installation of the instance of the application. The un-installation may be attributed to the publishing means that had led to the installation. The technique may enable determination of un-installations of the advertised mobile application from the mobile communication devices. Further, the technique may also enable determination of effectiveness of advertisement by not only associating installation of the advertised mobile application to one of the publishers, but also associating un-installations of the advertised mobile application to one of the publishers.

In an embodiment, the un-installations of the advertised mobile application may be associated with the advertising campaign and/or one or more parameters associated with the advertising campaign. The advertising campaign may include parameters, such as, targeting criteria, ad position and publisher(s), among other parameters.

The system may include at least one processor. The processor may be configured to receive information corresponding to mobile communication devices which have installed an application. Each instance of the application in the mobile communication devices may be attributed to a publisher among one or more publishers, which may have been responsible for that download and installation in the mobile communication device. Further, the system may be configured to keep track of each instance of the installed application till it is uninstalled. The aforementioned tracking of application on each of the mobile communication devices may be carried out by the system by configuring it to check the presence or absence of the application in the mobile communication device. The presence or absence of the application in the mobile communication device may be attributed to the publisher which may have been previously attributed for download and installation of the application in the mobile communication device.

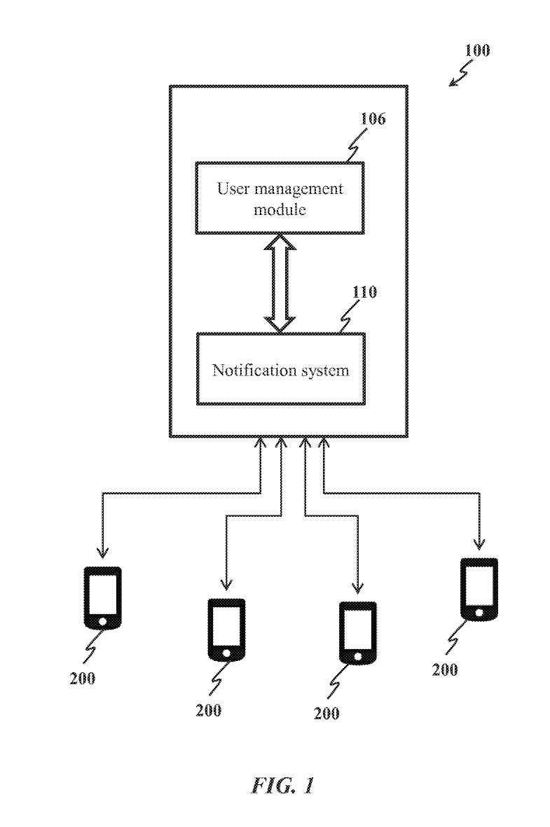

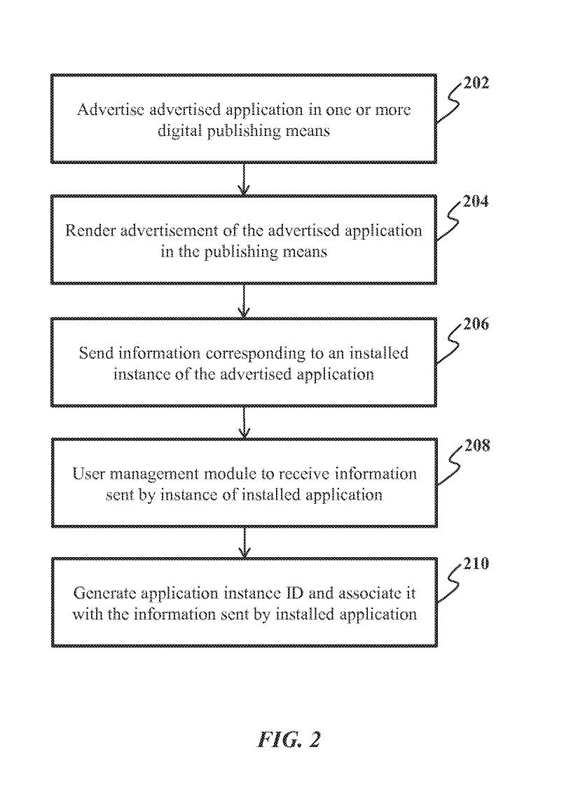

Referring to FIG. 2, at step 202, the advertised application may be advertised in one or more digital publishing means. Referring to FIG. 1, mobile communication devices 200 may receive advertisement of the advertised application via one or more publishing or digital publishing means (also refer to FIG. 2, at step 204). Digital publishing means may include SMS, email, social networking sites, professional networking sites, websites, mobile sites, mobile applications, search strings and search engines, to name a few. Further, users of mobile communication devices 200 may organically download the mobile application by searching for the same using search strings or by accessing digital market place where the mobile application may be available for downloading. Such means that may be responsible for downloading of the “advertised application” (may also be referred to as mobile application) may be referred to as publishing means.

Again referring to FIG. 2, at step 206, each instance of installed application in the mobile communication devices 200 may send information to a user management module 106. At step 208, the user management module 106 may receive information sent by instance of installed application. Further, at step 210, in an embodiment, a user management module 106 may be configured to generate an application instance ID for each instance of the advertised application installed in the mobile communication devices 200. Each application instance ID may be unique. The user management module 106 may record the time at which the advertised application was downloaded and/or installed. The application instance ID may be associated with the information sent by the installed application to the user management module 106.

In an embodiment, the information sent may include information corresponding to the publishing means.

In an embodiment, the information sent may include information corresponding to a source that led to the installation of the instance of the mobile application. The source may include search engine, search string and digital market place, among others.

In an embodiment, the information sent may include information corresponding to advertisement campaign responsible for the installation of the instance of the advertised application.

In an embodiment, the information sent may include information corresponding to the user of the mobile communication device 200 that installed the advertised application. Information corresponding to the user may include user name, age, gender, location and user's private/public/social profile, among others.

In an embodiment, the information sent may include information corresponding to the devices 200 which may have installed the advertised application. The device information may include one or more of number, phone number, type and/or version of the operating system, and hardware/software configurations, among others.

The user management module 106 may associate at least a part of the information received with the respective instance (instance ID) of the advertised. application.

A notification system 110 may be configured to enable tracking each instance of the advertised application. The instance of the application installed (advertised application) in the mobile communication devices 200 may be configured to communicate with the user management module 106, the notification system 110 and vice-versa.

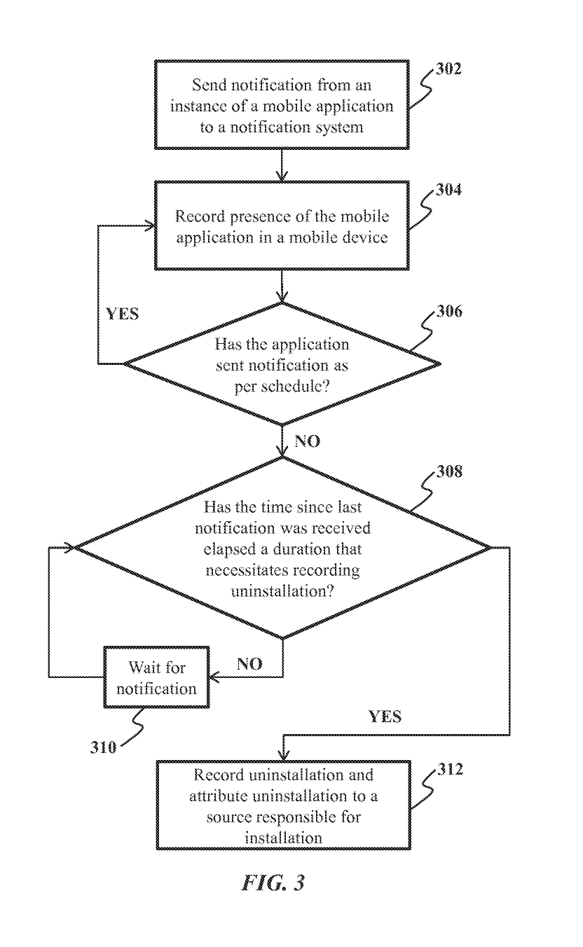

Referring to FIG. 3, at step 302, the instance of the application installed may be configured to send one or more notifications as per a predefined or configurable schedule to the notification system 110 confirming its presence in the mobile communication device 200. The intervals between two successive notifications sent by the instance of the application installed may be preconfigured. At step 304, the notification system 110 may be configured to record presence of the application in a mobile communication device 200 when one or more notification is sent by the instance of the application installed. At step 306, the notification system 110 may be configured to determine if the instance of the installed application has sent notification as per schedule. At step 310, in certain instances where the mobile communication devices 200 cannot access communication means (Ex: Internet) the instance of the application installed may wait for internet accessibility to send notifications to the notification system 110.

In other instances of inaccessibility to internet in the mobile communication devices 200, one or more other means (Ex: SMS) may be used to send notification to the notification system 110 to confirm its presence in the mobile communication devices 200.

Further, the user management module 106 may be configured to attribute the received notification to the application instance ID. At step 308, the notification system 110 may be configured to compare the duration elapsed for recording un-installation with the time of last notification received. If the duration for recording un-installation has not elapsed, then as per step 310, the notification system 110 may be configured to wait for notification. At step 312, if notifications, as expected, are not sent by the instance of the application installed to the notification system 110 to confirm its presence, then the user management module 106 may record un-installation. The un-installation may be attributed to the means or source that was responsible for the installation of the advertised application.

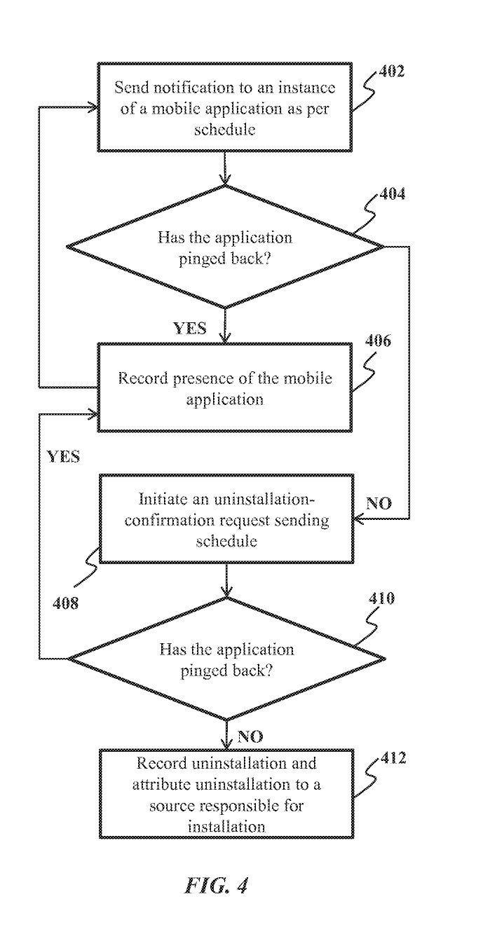

Referring to FIG. 4, at step 402, the notification system 110 may also be configured to communicate by sending push notifications to the instance of the application installed in the mobile communication devices 200. Push notifications may be sent to each of the mobile communication devices 200, which may have installed an instance of the advertised application. In response to the push notification sent to the mobile communication device 200, the advertised application if present, may ping back (send a notification), which may be received by the notification system 110. At step 404, the notification system 110 may be configured to check if the application has pinged back in response to push notification. If the application has pinged back, then at step 406, the notification system 110 may note the time at which the push notification was sent to each of the mobile communication devices 200 and record the presence of the mobile application. The presence of the advertised application in each of the mobile communication devices 200 may be ascertained by the ping sent by each of the mobile communication devices 200 and received by the notification system 110.

In the absence of the advertised application in a mobile communication device 200, the mobile communication devices 200 may not ping back to the notification system 110. The notification system 110 may not conclude that the advertised application may have been uninstalled from the mobile communication devices 200, only because a ping back in response to push notification was not received at first instance and/or first few instances.

At step 408, the backend notification system 110 may be configured to resend push notification (Ex: as per an un-installation-confirmation request sending schedule) to those mobile communication devices 200, which may have not responded to the push notification in the form of a ping back, at first instance and/or for predefined instances. After resending push notification to those mobile communication devices 200, which may have not responded to the push notification in the form of a ping back, for first few instances, some may respond in the form of a ping back. The time at which the ping back may have been received by the notification system 110 may be recorded. If a mobile communication device 200 does not respond to the push notification in the form of a ping back, for predefined instances, then the notification system 110 or user management module 106 may conclude that the respective advertised application may have been uninstalled (step 412).

In an embodiment, the user management module 106 may record the time of un-installation as the time at which the instance of the advertised application first failed to send the notification (ping pack) subsequent to which the instance failed to send such a notification (ping pack).

The notification system 110 may also be configured to send SMS to those mobile communication devices 200, which may have not responded to the push notification in the form of a ping back, at second instance and/or after predefined instances. In the absence of internet connectivity, push notifications sent to the mobile communication devices 200 may not reach and ping response may not be sent from the mobile communication devices 200. Sending one or more SMS to mobile communication devices 200 may be a feature that may be useful when the mobile communication devices 200 have do not have internet connectivity. The instance of application installed may be preconfigured to communicate using SMS with the notification system 110. If the instance of application installed is present in the mobile communication devices 200, a SMS in response to received SMS may be sent to the notification system 110. if the mobile communication device 200 does not respond to the SMS in the form of a SMS, for predefined instances, then the backend notification system 110 may conclude that the advertised application may have been uninstalled. If either ping or SMS as expected isn't sent by the instance of the application installed to the backend notification system 110 to confirm its presence, then the backend notification system 110 may record un-installation. Recorded un-installation may be associated with the application download instance ID and associated information, such as the source/publisher that was responsible for the download of the instance.

Further, the notification system 110 may be configured to resend push notification even to those mobile communication devices 200, which have ascertained the presence of the advertised application. The push notifications may be sent at preconfigured or configurable intervals. The presence or absence of an instance of an instance of the advertised application may be correlated with the application download instance ID and associated information. Further, the duration of time an instance of the advertised application may have been present on the devices 200 may also be determined using the discussed technique, and correlated with the application download instance ID and associated information Similarly, the user information/profile and/or device information/profile and the duration of time the advertised application was installed may be correlated and/or attributed with/to the information associated with the application instance ID.

One or more embodiment may enable determining effectiveness of one or more digital advertizing means and quality of users acquired through a advertising campaign/agency.

One or more embodiment may enable associating not just the installation, but also the un-installation of advertised application to the advertising means responsible for the initial installation.

One or more embodiment may enable associating duration for which the advertised application was installed to the advertising means responsible for the initial installation.

One or more embodiment may enable associating user profiles who installed the advertised application to the advertising means responsible for the initial installation.

One or more embodiment may enable associating device profiles, which installed the advertised application to the advertising means responsible for the initial installation.

It shall be noted that the processes described above is described as sequence of steps, this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications; these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. A system comprising at least one processor configured to:
receive information associated with an instance of an application installed in a mobile communication device;
receive one or more notifications from the instance of the application confirming its presence in the mobile communication device;
record un-installation of the instance of the application from the mobile communication device upon failure to receive expected one or more notifications confirming presence of the instance of the application in the mobile communication device; and
attribute the un-installation to at least a part of the information associated with the instance of the application.

2. The system according to claim 1, wherein the part of the information comprises advertisement campaign responsible for the installation of the instance of the application.

3. The system according to claim 1, wherein the part of the information comprises information corresponding to a publisher responsible for the installation of the instance of the application.

4. The system according to claim 1, wherein the part of the information comprises information corresponding to a search string that led to the installation of the instance of the application.

5. The system according to claim 1, wherein the part of the information comprises information corresponding to a source that led to the installation of the instance of the application.

6. The system according to claim 1, wherein the part of the information comprises information corresponding to a user of the mobile communication device.

7. The system according to claim 1, wherein the part of the information comprises information corresponding to the mobile communication device.

8. The system according to claim 1, wherein the application is configured to send the notification as per a predefined schedule.

9. The system according to claim 1, wherein the processor is further configured to send a request to the instance of the application requesting notification from the instance of the application confirming its presence in the mobile communication device.

10. The system according to claim 9, wherein the processor is further configured to record un-installation of the instance of the application on failure to receive the notification from the instance of the application in response to one or more requests sent as per an un-installation-confirmation request sending schedule.

11. A method comprising:
sending information associated with an instance of an application installed in a mobile communication device;
sending one or more notifications confirming presence of the instance of the application in the mobile communication device, thereby enabling recording un-installation of the instance of the application from the mobile communication device upon failure to send expected one or more notifications confirming the presence of the instance of the application in the mobile communication device; and
attributing the un-installation to at least a part of the information associated with the instance of the application.
